(19) United States
(12) Patent Application Publication
(10) Pub. No.: US 2014/0304287 A1
(43) Pub. Date: Oct. 9, 2014

(54) SYSTEM AND METHOD FOR LOCKLESS READERS OF B-TREES

(71) Applicant: PERFORCE SOFTWARE, INC., Alameda, CA (US)

(72) Inventors: Jeffrey A. Anton, Oakland, CA (US); Christopher D. Seiwald, Alameda, CA (US)

(73) Assignee: PERFORCE SOFTWARE, INC., Alameda, CA (US)

(21) Appl. No.: 14/214,481

(22) Filed: Mar. 14, 2014

Related U.S. Application Data
(60) Provisional application No. 61/800,964, filed on Mar. 15, 2013.

(51) Int. Cl. G06F 17/30

(52) U.S. Cl. CPC G06F 17/30327
USPC 707/758; 707/797

(57) ABSTRACT

A system configured to associate information with a file. The system including memory, one or more processors, and one or more modules stored in memory and configured for execution by the one or more processors. The modules including a reader module configured to perform a lockless read of a B-tree stored in an operating system file and a writer module configured to perform a write process to the B-tree.

### CROSS-REFERENCE TO RELATED APPLICATION

This application claims the benefit of, and priority to, U.S. Provisional Patent Application Ser. No. 61/800,964, filed on Mar. 15, 2013, entitled “SYSTEM AND METHOD FOR LOCKLESS READERS OF B-TREES,” by Jeffrey A. Anton, et al., the entire disclosure of which is hereby incorporated in its entirety herein by reference.

### FIELD

Embodiments of the invention relate to B-tree implementations. In particular, embodiments of the invention relate to a system and methods for lockless readers of B-trees.

### BACKGROUND

Shared memory caching is usually used for B-tree implementations but its use makes the system vulnerable to software process crashes corrupting that shared memory and make it more likely that failure of one user's command will cause the whole system to crash and require some recovery operation. Further, file level locking has become a performance problem.

### SUMMARY

A system configured to associate information with a file. The system including memory, one or more processors, and one or more modules stored in memory and configured for execution by the one or more processors. The modules including a reader module configured to perform a lockless read of a B-tree stored in an operating system file and a writer module configured to perform a write process to the B-tree.

Other features and advantages of embodiments will be apparent from the accompanying drawings and from the detailed description that follows.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram of a system to perform a lockless read of a B-tree according to an embodiment;

FIG. 2 illustrates a block diagram of a distributed system according to an embodiment;

FIG. 3 illustrates a flow diagram for writing according to an embodiment;

FIG. 4 illustrates a flow diagram for a lockless read of a B-tree according to an embodiment;

FIG. 5 illustrates a flow diagram for a locked read of a B-tree according to an embodiment;

FIG. 6 illustrates a flow diagram for writing according to an embodiment;

FIG. 7 illustrates a flow diagram for a lockless read of a B-tree according to an embodiment using a lockless reader; and

FIG. 8 illustrates a block diagram of a system according to an embodiment.

### DETAILED DESCRIPTION

Embodiments of a system and methods for a lockless read protocol whereby the operating system (“OS”) files may be read without the reader holding a read/shared lock. By avoiding shared memory, embodiments of this B-tree implementation are more robust. In place of shared memory, each process has its own small memory cache and the disk pages are read from and written to locked OS files. An embodiment of a B-tree implementation includes incrementing a sequence number which references the scope of the whole file and which is written on pages in the file whenever they are modified by a writing process. This sequence number will have the same value throughout a single write operation, that is a write operation will lock the file, read the previous sequence number, increase that value to a new value, write that new value on all pages which it writes and finally just before a writing process finishes its write operation, it writes the new sequence number onto a meta page, a special first page of the file with various configuration information then unlock the file. Reading processes will read that meta page at the start of their operation, then proceed to read pages from the file, but if they ever read a page with a sequence number later than the number that was initially read from the meta page the reader will know that part of the file has changed and report that the data has changed or is unstable. In such cases the reader may wait or discard all of its cached information and restart the operation it is trying to perform or the reader may reposition itself looking for a given B-tree structure that may have shifted.

Sequence numbers have been used in B-Trees and similar disk based data structures for many years, however they are usually incremented for each page as it is modified and thus the source of these sequence numbers needs to be a high speed resource such as shared memory. Thus, embodiments of the B-Tree implementation avoid shared memory for sequence numbers. Sequence numbers include, but are not limited to, page identifiers (“PID”), generation number, or other identifier.

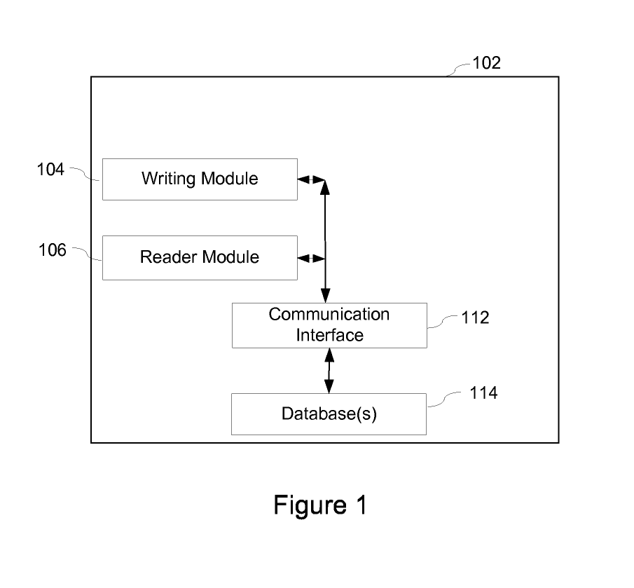

FIG. 1 illustrates a block diagram of an embodiment of a system to associate information to a file according to an embodiment. For an embodiment, system 102 may be a computer, a server, a tablet, a smart phone, a user device or other device configured to associate information with a file. The embodiment illustrated in FIG. 1 includes a writing module 104. For an embodiment, a writing module 104 is coupled with a reader module 106, a communication interface 112, and one or more databases 114. The writing module 104, according to an embodiment, is configured to perform a writing process to one or more databases 114 using techniques including those described herein. A reader module 106 is configured to perform one or more reading process from one or more databases 114 using techniques including those described herein. According to an embodiment, a writing module 104 and/or a reader module is coupled with a database 114 through a communication interface 112.

In an embodiment, a reader module 106 is configured to retrieve information, a file, or other data from a database 114 by sending a request to a communication interface 112. A request may include, but is not limited to, a file name, an address, a row number, a column number or other reference including those known in the art. In response to receiving a request, a communication interface 112 is configured to access one or more locations in a database 114 that includes the requested file or information. According to an embodiment, a communication interface module 112 is configured to receive and to retrieve information from one or more databases 114. An embodiment includes a communication interface 112 configured to access and/or retrieve information from, for example, a memory, a database, or an external server. Similarly, an embodiment includes a communication interface 112 configured to store files or information, for example, in a memory, a database, or an external server. In an embodiment, a communication interface 112 stores a file, information, or data based on receiving a request from a writing module 104.

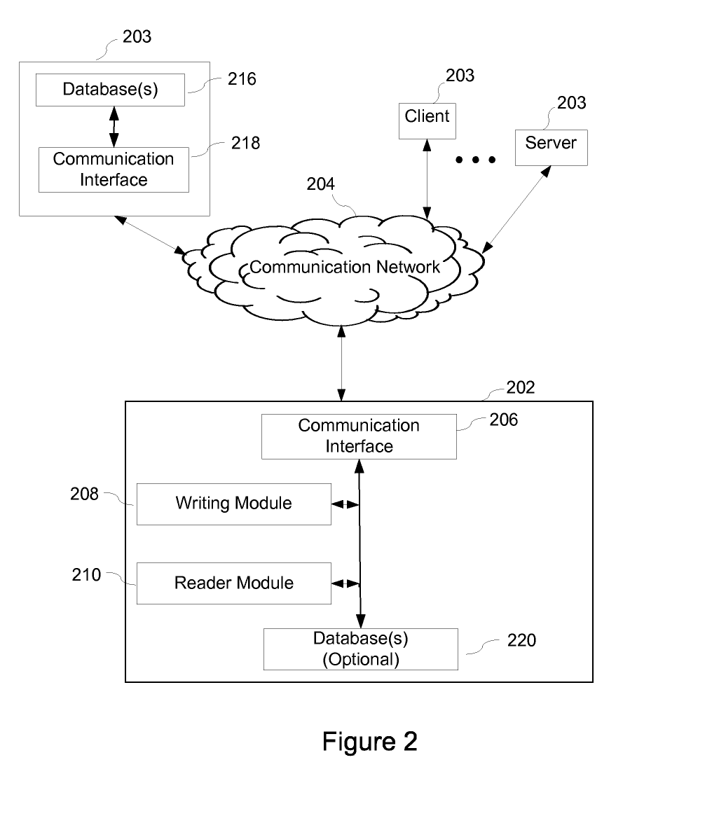

FIG. 2 illustrates a block diagram of a distributed system of including an embodiment of a system 202 to perform a lockless read of a B-tree according to an embodiment. For an embodiment, system 202 may be configured to operate as a server in a client-server relationship. For another embodiment system 202 may be configured to operate in a peer-to-peer relationship with one or more peers over a communication network 204. Yet another embodiment includes a system 202 coupled with one or more modules of the system over a communication network 204. A communication network 204 includes, but is not limited to, a wide area network (“WAN”), such as the Internet, a local area network (“LAN”), a wireless network, or other type of network. According to embodiments, one or more devices 203 may be in communication with system 202 through a communication network 204. Devices 203 include, but are not limited to, a user device, a server, an external database, a peer, or other device that includes one or more modules configured to performing part of or all of one or more methods to associate information with a file or to receive results of a system configured to associate information with a file, such as those described herein.

According to the embodiment of the system 202 illustrated in FIG. 2, an embodiment of a device 203 includes one or more a database(s) 216 coupled with a communication interface 218. A database 216 for an embodiment may be configured to store data, a file, or other information. A communication interface 206, 218, according to an embodiment, is configured to manage communication through a communication network 204 using communication protocols. For some embodiments, a communication interface 206 in a system 202 manages one or more communication sessions between a system 202 and one or more devices 203. A communication interface 206, 218 may also convert or package data or information into the appropriate communication protocol depending on the protocol used by a device 203. According to some embodiments, a communication interface 206, 218 may be configured to use one or more communication protocols for one or more communication layers, such communication protocols include, but are not limited to, hypertext transfer protocol (“HTTP”), transmission control protocol (“TCP”), Internet Protocol (“IP”), user datagram protocol (“UDP”), file transfer protocol (“FTP”), or any other protocol.

The embodiment of a system 202 as illustrated in FIG. 2, in addition to a communication interface 206, includes a writing module 208, a reader module 210, and optionally one or more databases 220. These modules are coupled with each other and configured to perform a lockless read of a B-tree using techniques including those described herein.

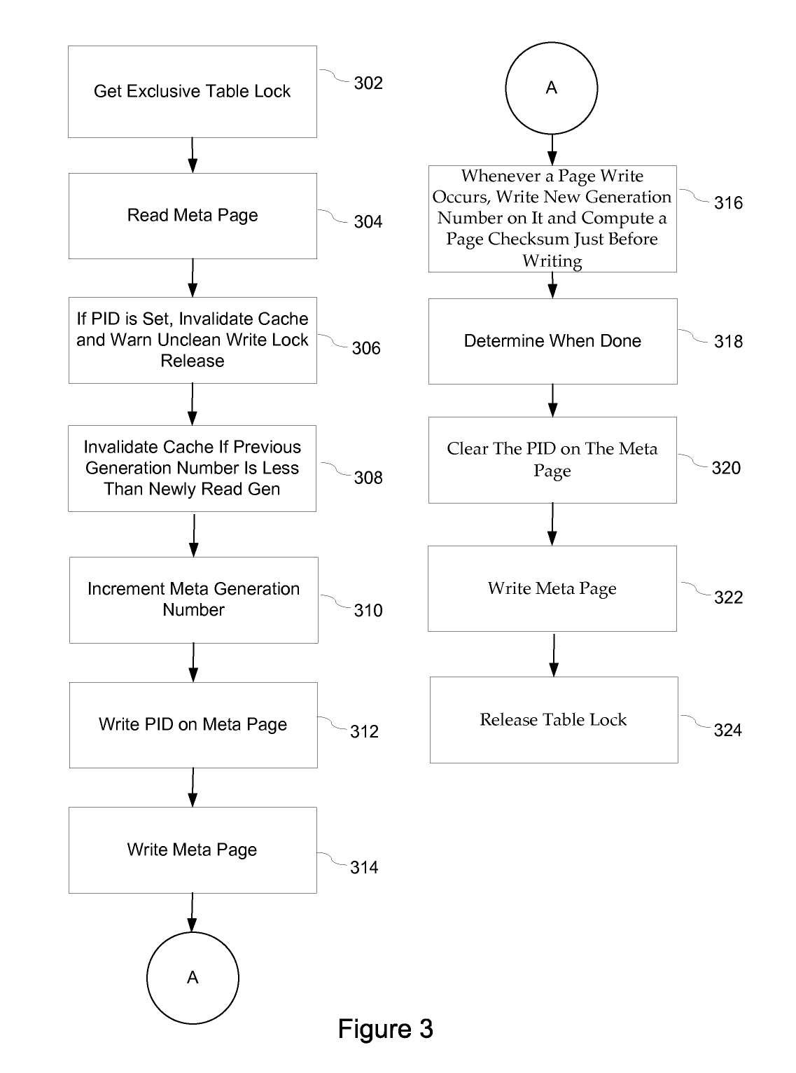

FIG. 3 illustrates a flow diagram for writing according to an embodiment. Implementing writers includes get exclusive table lock (302); read meta page (304); If PID is set, invalidate cache and warn unclean write lock release (306); invalidate cache if previous generation number is less than (<) newly read gen (308); Increment Meta Generation number (310); Write PID on meta page (312); Write Meta Page (314); Whenever a page write occurs, write new generation number on it Compute a page checksum just before writing (316); Determine when done (318), Clear the PID on the meta page (320); Write Meta Page (322); and Release table lock (324).

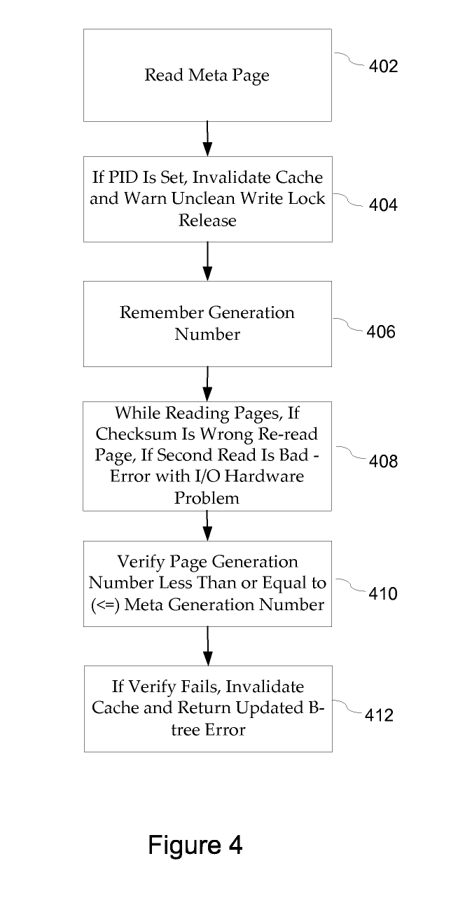

FIG. 4 illustrates a flow diagram for a lockless read of a B-tree according to an embodiment using a lockless reader. The method for a lockless reader including reading a meta page (402); if PID is set, invalidating the cache and warning of an unclean write lock release (404); remembering a generation number (406); while reading pages, if a checksum of a page is wrong re-reading the page, if a second read is bad—determining that there is an error with the input/output (“I/O”) or other hardware problem (408); verifying a page generation number is less than or equal to (←) a meta generation number (410); and if verifying fails, invalidating the cache and returning an updated B-tree Error (412).

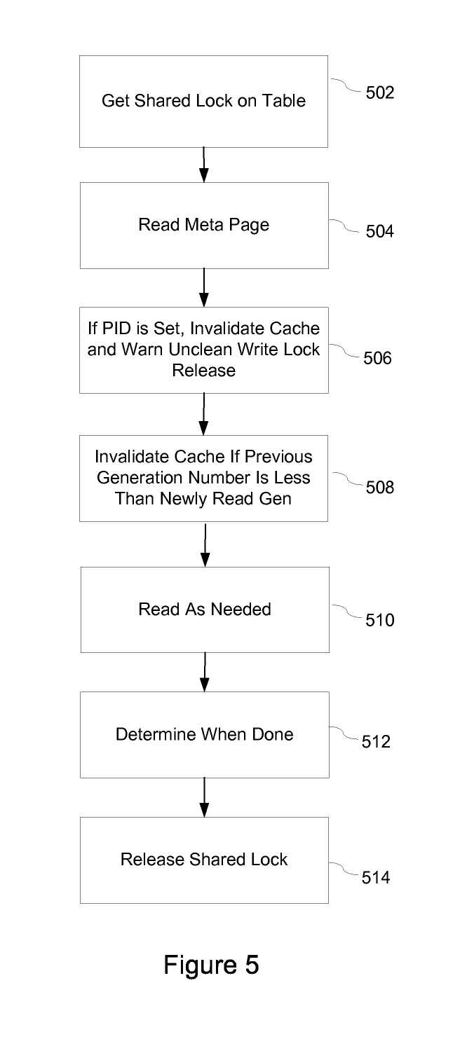

FIG. 5 illustrates a flow diagram for a locked read of a B-tree according to an embodiment by using a locked reader. The method for using a locked reader includes getting a shared lock on a table (502); reading a meta page (504); if PID is set, invalidating a cache and warning of an unclean write lock release (506); invalidating the cache if a previous generation number is less than (<) a newly read generation number (508); reading as needed (510); and determining when done (512), releasing the shared lock (514).

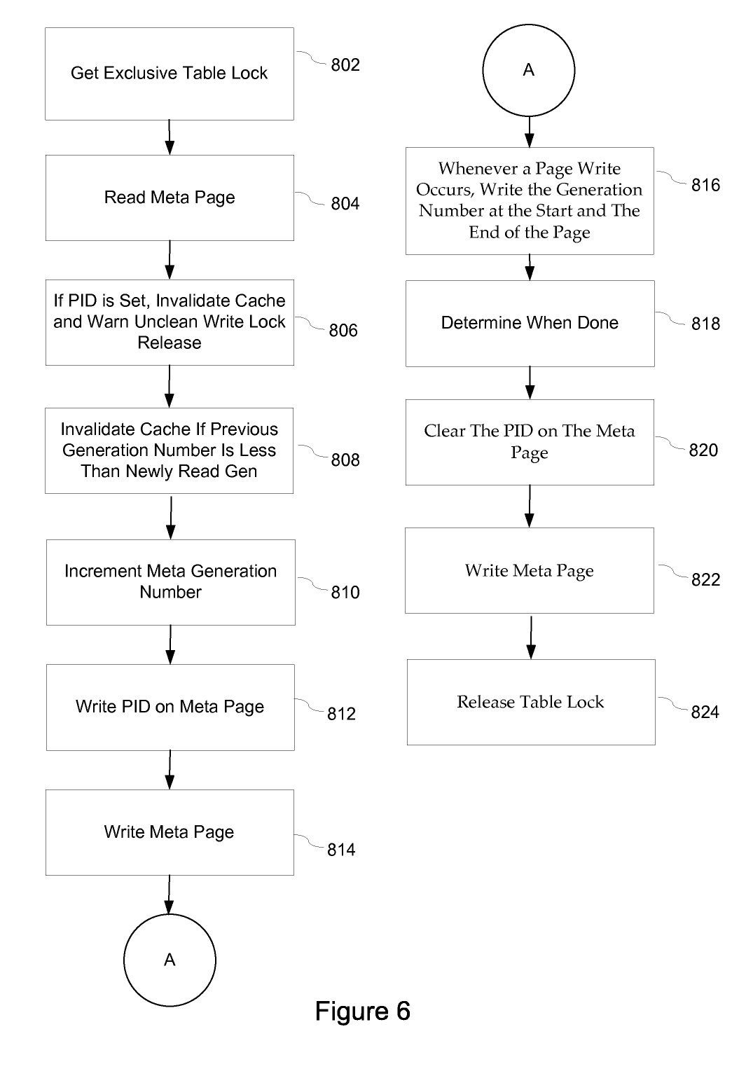

FIG. 6 illustrates a flow diagram for writing according to an embodiment. Implementing writers includes get exclusive table lock (802); read meta page (804); If PID is set, invalidate cache and warn unclean write lock release (806); invalidate cache if previous generation number is less than (<) newly read gen (808); Increment Meta Generation number (810); Write PID on meta page (812); Write Meta Page (814); Whenever a page write occurs, write the generation number at the start and the end of the page (816); Determine when done (818) , Clear the PID on the meta page (820); Write Meta Page (822); and Release table lock (824).

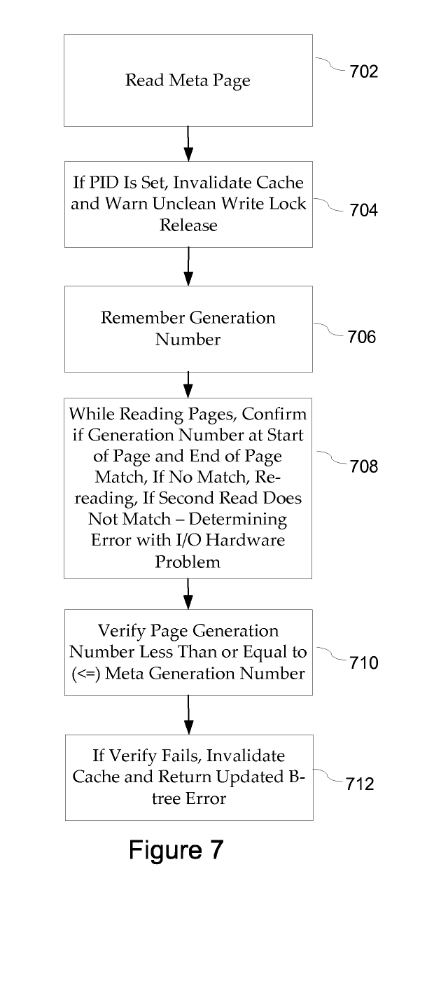

FIG. 7 illustrates a flow diagram for a lockless read of a B-tree according to an embodiment using a lockless reader. The method for a lockless reader including reading a meta page (702); if PID is set, invalidating the cache and warning of an unclean write lock release (704); remembering a generation number (706); while reading pages, confirm if generation number at the start of the page and the end of the page match, if not re-reading the generation numbers and if the second read does not match—determining that there is an error with the input/output (“I/O”) or other hardware problem (708); verifying a page generation number is less than or equal to (←) a meta generation number (710); and if verifying fails, invalidating the cache and returning an updated B-tree Error (712).

A method to escalate from a lockless to a locked reading includes performing a locked reader method as described herein.

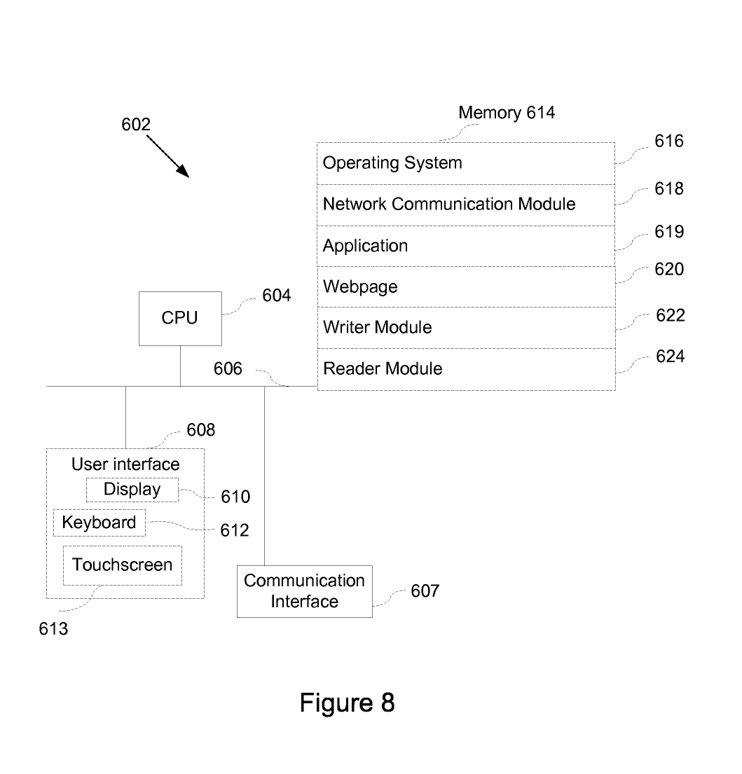

FIG. 8 illustrates an embodiment of system 602 that may be implemented as a client, server, a peer or other device that implements the methods described herein. The system 602, according to an embodiment, includes one or more processing units (CPUs) 604, one or more network or other communication interfaces 607, memory 614, and one or more communication buses 606 for interconnecting these components. The system 602 may optionally include a user interface 608 comprising a display device 610, a keyboard 612, touchscreen 613, and/or other input/output devices. Memory 614 may include high speed random access memory and may also include non-volatile memory, such as one or more magnetic or optical storage disks. The memory 614 may include mass storage that is remotely located from CPUs 604. Moreover, memory 614, or alternatively one or more storage devices (e.g., one or more nonvolatile storage devices) within memory 614, includes a computer readable storage medium. The memory 614 may store the following elements, or a subset or superset of such elements:
an operating system 616 that includes procedures for handling various basic system services and for performing hardware dependent tasks;
a network communication module 618 (or instructions) that is used for connecting the system 602 to other computers, clients, peers, systems or devices via the one or more communication network interfaces 607 and one or more communication networks, such as the Internet, other wide area networks, local area networks, metropolitan area networks, and other type of networks;
an application 619 including, but not limited to, a web browser, a document viewer or other application for viewing information;
a webpage 620 for indicating results, status of the method, or providing an interface for user feedback for the method as described herein;
a writer module determination module 622 (or instructions) for writing as described herein; and
a reader module 624 (or instructions) for reading using a locked reader and/or a lockless reader, as described herein.

Although FIG. 8 illustrates system 602 as a computer that could be a client and/or a server system, the figures are intended more as functional descriptions of the various features which may be present in a client and a set of servers than as a structural schematic of the embodiments described herein. As such, one of ordinary skill in the art would understand that items shown separately could be combined and some items could be separated. For example, some items illustrated as separate modules in FIG. 6 could be implemented on a single server or client and single items could be implemented by one or more servers or clients. The actual number of servers, client, or modules used to implement a system 602 and how features are allocated among them will vary from one implementation to another, and may depend in part on the amount of data traffic that the system must handle during peak usage periods as well as during average usage periods. In addition, some modules or functions of modules illustrated in FIG. 6 may be implemented on one or more systems remotely located from other systems that implement other modules or functions of modules illustrated in FIG. 6.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A system configured to associate information with a file comprising:
memory;
one or more processors; and
one or more modules stored in memory and configured for execution by the one or more processors, the modules comprising:
a reader module configured to perform a lockless read of a B-tree stored in an operating system file; and
a writer module configured to perform a write process to said B-tree.

2. The system of claim 1, wherein a reader module configured to perform a lockless read of a B-tree includes said reader module being configured to read a first sequence number associated with said B-tree.

3. The system of claim 2, wherein said first sequence number is read from a meta page associated said B-tree.

4. The system of claim 2, wherein said reader module configured to perform said lockless read of said B-tree further includes said reader module being configured to read a second sequence number associated with a first page of said B-tree.

5. The system of claim 4, wherein said reader module is further configured to compare said second sequence number with said first sequence number.

6. The system of claim 4, wherein said reader module is further configured to determine if said second sequence number is later than said first sequence number.

7. The system of claim 6, wherein said reader module is further configured to discard said B-tree stored in said operating system file upon a determination that said second sequence number is later than said first sequence number.

8. A method for associating information with a file comprising:
at one or more systems including one or more processors and memory:
performing a lockless read of a B-tree stored in an operating system file; and
performing a write process to said B-tree.

9. The method of claim 8 further comprising:
reading a first sequence number associated with said B-tree.

10. The method of claim 9, wherein said first sequence number is read from a meta page associated with said B-tree.

11. The method of claim 9 further comprising:
reading a second sequence number associated with a first page of said B-tree.

12. The system of claim 11 further comprising:
comparing said second sequence number with said first sequence number.

13. The method of claim 11 further comprising:
determining if said second sequence number is greater than said first sequence number.

14. A computer readable storage medium storing one or more programs to be executed by one or more processors for performing a method, the method comprising:
performing a lockless read of a B-tree stored in an operating system file; and
performing a write process to said B-tree.

15. The computer readable storage medium of claim 14 storing one or more programs to be executed by one or more processors for performing the method, the method further comprising:
reading a first sequence number associated with said B-tree.

16. The computer readable storage medium of claim 15, wherein said first sequence number is read from a meta page associated with said B-tree.

17. The computer readable storage medium of claim 15 storing one or more programs to be executed by one or more processors for performing the method, the method further comprising:
reading a second sequence number associated with a first page of said B-tree.

18. The computer readable storage medium of claim 17 storing one or more programs to be executed by one or more processors for performing the method, the method further comprising:
comparing said second sequence number with said first sequence number.

19. The computer readable storage medium of claim 17 storing one or more programs to be executed by one or more processors for performing the method, the method further comprising:
determining if said second sequence number is later than said first sequence number.

20. The computer readable storage medium of claim 19 storing one or more programs to be executed by one or more processors for performing the method, the method further comprising:
discarding said B-tree stored in said operating system file upon said determination that said second sequence number is later than said first sequence number.
